(19) United States
(12) Patent Application Publication
(10) Pub. No.: US 2024/0051653 A1
(43) Pub. Date: Feb. 15, 2024

(54) BALLOON ALTITUDE CONTROL

(71) Applicant: Lux Aerobot inc., Alma (CA)

(72) Inventors: Adithya Rajendran, Melbourne (AU); Vincent Lachance, Montreal (CA); Jesus Carl Marinus Thibault, Newfoundland (CA)

(73) Assignee: Lux Aerobot inc., Alma (CA)

(21) Appl. No.: 17/887,041

(22) Filed: Aug. 12, 2022

(51) Int. Cl. B64B 1/62; B64B 1/44; B64B 1/52

(52) U.S. Cl. CPC B64B 1/62; B64B 1/44; B64B 1/52

(57) ABSTRACT

Balloon altitude control is provided. A system includes a balloon formed from a material having latex. The balloon includes a top portion that is narrower than a middle portion of the balloon. The balloon includes a bottom portion that is in contact with a cable to tether the balloon to a gondola. The bottom portion of the balloon is narrower than the middle portion of the balloon. The system includes a first valve located at the top portion of the balloon. The first valve can open to release gas from within the balloon, and close to at least partially prevent the release of the gas from within the balloon. The system includes a gondola. The gondola includes a control system that can open the first valve to release the gas responsive to a determination to decrease buoyancy of the system.

### BACKGROUND

Portions of the Earth can be observed using aerial vehicles or satellites. However, it can be challenging to efficiently observe portions of the earth due to high energy consumption of aerial vehicles or deploying satellites into orbit, or the low field of view of aerial drones.

### SUMMARY

A technical solution of this disclosure can be directed to systems, methods, and apparatus for balloon altitude control. The system can include one or more balloons formed from latex that are tethered to a gondola via a cable. The balloons can be filled with a gas that is less dense than air, such as helium or hydrogen. To adjust the buoyancy of the platform, a control system located in the gondola of the platform can instruct a valve attached to the balloon to open or close. However, due to the gas occupied within the balloon being more dense than air, it can be challenging to release gas at a desired rate in order to decrease the buoyancy at a desired rate. Systems, methods, and apparatus of this technical solution can include a valve located at a top portion of the balloon that can be actuated by the control system to open to vent or release the gas within the balloon. The top portion or the top of the balloon can refer to the portion that is above or located further away from the surface of the earth (e.g. at a higher altitude). The top portion of the balloon can have less gravitational pull from the surface of the earth relative to the bottom portion of the balloon. Since the gas within the balloon is less dense than air, the gas can escape from within the balloon to outside of the balloon through the valve at the top portion at a greater rate relative to a valve that may be located on the bottom portion of the balloon. As the gas is vented from the balloon, the buoyancy of the platform or balloon can decrease, thereby causing the balloon or platform to decrease in altitude.

An aspect of this technical solution can be directed to a system. The system can include a balloon. The balloon can be formed from a material having latex. The balloon can include a top portion that is narrower than a middle portion of the balloon. The balloon can include a bottom portion that is narrower than the middle portion of the balloon. The bottom portion can be in contact with a cable to tether the balloon to a gondola. The system can include a first valve located at the top portion of the balloon. The first valve can open to release gas from within the balloon. The first valve can close to at least partially prevent the release of the gas from within the balloon. The system can include the gondola, which can include a control system. The control system can include one or more processors, coupled to memory. The control system can open, responsive to a determination to decrease buoyancy of the system, the first valve to release the gas.

An aspect of this technical solution can be directed to a method. The method can include providing a balloon, formed from a material having latex. The balloon can include a top portion that is narrower than a middle portion of the balloon. The balloon can include a bottom portion, that is narrower than the middle portion. The bottom portion can be in contact with a cable to tether the balloon to a gondola. The method can include providing a first valve, located at the top portion of the balloon. The first valve can open to release gas from within the balloon, and close to at least partially prevent the release of the gas from within the balloon. The method can include providing a control system, comprising one or more processors coupled to memory, to open the first valve to release the gas.

An aspect of this technical solution can be directed to an apparatus. The apparatus can include a balloon, formed from a material having latex. The balloon can include a top portion that is narrower than a middle portion of the balloon. The balloon can include a bottom portion, that is narrower than the middle portion of the balloon, in contact with a cable to tether the balloon to a gondola. The apparatus can include a valve system, coupled to the balloon via an attachment point on the top portion of the balloon. The valve system can include an actuator, a valve, and a wireless interface card. The valve system can receive, from a control system comprising one or more processors, coupled to memory, a command to open the valve. The valve system can actuate the valve to open the valve and release gas from within the balloon.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of an example system for altitude control.

FIG. 2 is an illustration of an example system for altitude control.

FIG. 3 is an illustration of an example system for altitude control.

FIG. 4 is an illustration of an example system for altitude control.

FIG. 5 is an illustration of an example system for altitude control.

FIG. 6 is an illustration of an example method of performing altitude control.

FIG. 7 is an illustration of an example method of performing altitude control.

FIG. 8 is a block diagram illustrating an architecture for a computer system that can be employed to implement elements of the systems, apparatus, and methods described and illustrated herein, including, for example, the examples depicted in FIGS. 1-7.

### DETAILED DESCRIPTION

Following below are more detailed descriptions of various concepts related to, and implementations of, methods, apparatuses, and systems of a platform for altitude control. The various concepts introduced above and discussed in greater detail below may be implemented in any of numerous ways.

A technical solution of this disclosure can be directed to systems, methods, and apparatus for balloon altitude control. The system can include one or more balloons formed from latex that are tethered to a gondola via a cable. The balloons can be filled with a gas that is less dense than air, such as helium or hydrogen. To adjust the buoyancy of the platform, a control system located in the gondola of the platform can instruct a valve attached to the balloon to open or close.

The balloon can vent the gas filling the balloon using a valve and thereby adjust the buoyancy of the system. To decrease the buoyancy and lower the balloon towards the surface of the earth, the system can vent the gas from within the balloon. However, the rate at which the gas is vented can impact the rate at which the balloon can be lowered to the surface of the earth. Thus, systems, methods and apparatus of this technical solution can include one or more balloons with a valve located at a top portion of the balloon. By attaching the valve to the top portion of the balloon, this technical solution can vent gas faster than if the valve was located at the bottom of the balloon because the gas within the balloon is less dense than the air outside of the balloon. A gas that that is less than dense than air can float or rise above the air. Thus, this technical solution can provide rapid venting of the gas using a top valve, relative to a bottom valve. In some cases, the technical solution can open the top valve for rapid venting, and open the bottom valve for slower, or more controlled venting relative to the top valve.

To attach the valve to the top portion of the balloon, this technical solution can use latex balloons with a double neck configuration. For example, the balloon can include a neck at the top portion and a neck at the bottom portion. The neck at the top portion can include an attachment point for a valve. The neck at the bottom portion can include an attachment point for a cable to tether the bottom portion of the balloon to the gondola. The neck at the bottom portion can be used to fill the balloon with the gas before the balloon is deployed. The thickness of the latex material at the top and bottom necks can be greater than the thickness of the latex material at the middle portion of the balloon.

The control system of this technical solution can store, in memory, information about the location of the valve for each balloon in the system and determine whether and how much to open the valve in order to control the rate at which gas is vented, thereby controlling the buoyancy and rate of descent of the platform. For example, in order to expedite landing the balloon responsive to an instruction or trigger of a geofence, this technical solution can open top valves to vent gas at a greater rate and expedite landing the balloon. Thus, this technical solution can facilitate landing the balloon within a target geofence by providing a greater rate of descent, thereby allowing the recovery of the balloon or its components thereof. In some cases, the system can provide for a greater dynamic range of altitude of control by using a top valve to vent gas at a greater rate relative to a bottom valve, but canceling out the greater rate of venting by releasing material from a ballast tank. This technical solution can provide a greater overall rate of descent, while also allowing for a more granular control over the rate of descent.

Further, the balloons of this technical solution can be constructed using less expensive materials, such as latex.

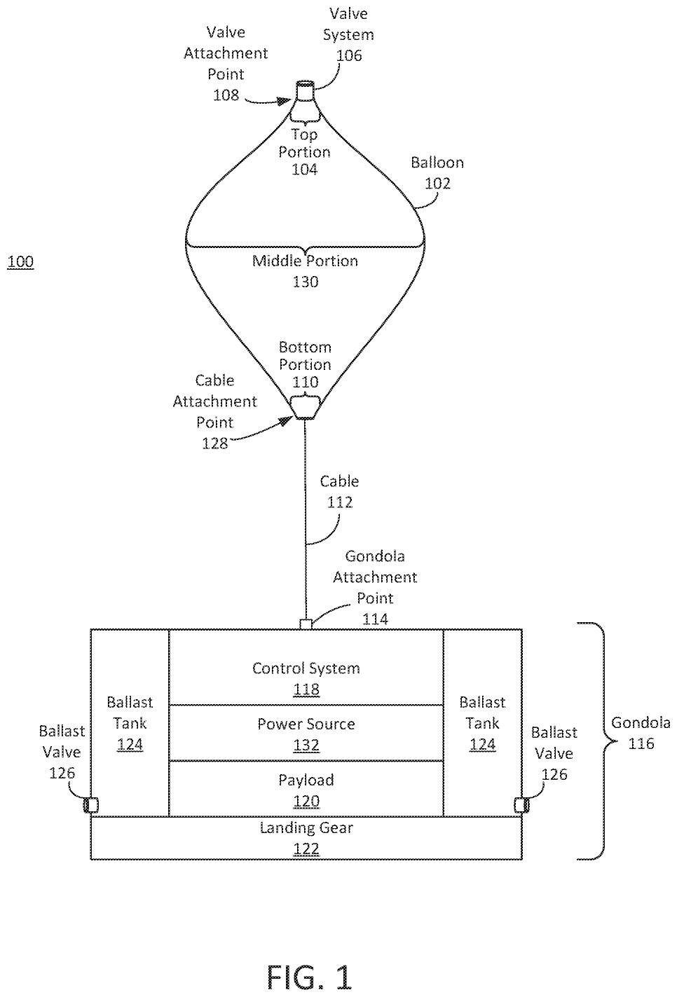

FIG. 1 is an illustration of an example system 100 for balloon altitude control. The system 100 can include a balloon 102. The balloon can be filled with a gas. The gas can be any type of gas. The gas can be a combination of different types of gases. The gas can have a density that is less than the density of air. For example, the gas within the balloon can have a density that is less than the air that is outside the balloon. The air can be outside, environmental air. Examples gases that can be used to fill the balloon an include hydrogen or helium.

The balloon 102 can include a top portion 104. The top portion 104 can include an opening at an end of the of the top portion 104 through which a valve system 106 can be inserted and coupled to the balloon 102 via a valve attachment point 108. The top portion 104 can refer to a portion of the balloon 102 that is opposite the bottom portion 110 of the balloon. The top portion 104 of the balloon 102 can refer to a portion of the balloon that is further away from the cable 112, gondola 116, or surface of the earth relative to the bottom portion 110. The top portion 104 of the balloon 102 can refer to a portion of the balloon that, when the balloon is at least partially filled with gas or deployed, is further away from the surface of the earth than the bottom portion 110 of the balloon. The top portion 104 of the balloon 102 can, when the balloon is at least partially filled with the gas, be at a higher altitude than the bottom portion 110 of the balloon.

The top portion 104 can be narrower than a middle portion 130 of the balloon 102. The middle portion 130 can be a portion of the balloon 102 that is in between the bottom portion 110 and the top portion 104 of the balloon. The middle portion 130 of the balloon 102 can refer to a region of the balloon 102 that is in between the top portion 104 and the bottom portion 110.

The top portion 104 can be different than the middle portion 130 of the balloon 102. The top portion 104 can have a different characteristic or attribute relative to the middle portion 130 of the balloon. For example, while the top portion 104 and the middle portion 130 can both be formed of a same material, such as latex, the top portion 104 can be thicker than the middle portion 130. The thickness of the material that forms the top portion 104 can be greater than the thickness of the material that forms the middle portion 130 of the balloon 102. The thickness of the material that forms the balloon 102 throughout the middle portion 130 can be uniform. The thickness of the material that forms the balloon 102 can be uniform throughout the balloon except for the top portion 104 and the bottom portion 110. The thickness of the material that forms the top portion 104 and the bottom portion 110 can be thicker than the material that forms the middle portion 130 of the balloon so as to provide greater structural integrity or to facilitate an attachment point, for example. Thus, a first thickness of the material at the top portion 104 of the balloon 102 can be greater than a second thickness of the material at the middle portion 130 of the balloon 102.

The top portion 104 of the balloon 102 can have a different shape relative to the middle portion 130 of the balloon 102. The top portion 104 of the balloon 102 can be shaped like a neck. The top portion 104 can have a shape that is based on a neck profile. The contour of the top portion 104 can correspond to, resemble, or otherwise be based on a neck profile. A neck profile can refer to a profile or shape that tapers or becomes narrower from one end to the other end. For example, a first end of the top portion 104 that is adjacent to, or closer to, the middle portion 130 can be wider than a second end of the top portion 104 that is opposite the first end. The second end of the top portion 104 can face an exterior of the balloon 102. The second end of the top portion 104 can be in contact with a valve attachment point 108 or a valve system 106, for example.

The balloon 102 can include a valve attachment point 108. The valve attachment point 108 can be located at the top portion 104 of the balloon 102. The top portion 104 of the balloon can include the valve attachment point 108. The valve attachment point 108 can be inserted into an opening at the top portion 104 of the balloon 102. For example, a second end of the top portion 104 that is opposite a first end of the top portion 104 that is adjacent to the middle portion 130 can include the opening. The valve attachment point 108 can refer to a location or portion of the balloon 102 at which the valve system 106 contacts the balloon 102. the valve attachment point 108 can be designed, constructed and operational to receive the valve system 106. The valve attachment point 108 can be designed, constructed, and operational to couple the valve system 106 to the balloon 102 at the top portion 104 of the balloon 102. The valve attachment point 108 can mechanically couple, attach, fix, or hold the valve system 106 in contact with the top portion 104 of the balloon 102 as the balloon 102 is deployed.

The valve attachment point 108 can be formed of the same material as the top portion 104. The valve attachment point 108 can include a different component or material relative to the balloon 102 material. For example, the valve attachment point 108 can include a nozzle that can be inserted into the top portion 104 of the balloon 102. The valve attachment point 108 can be formed of any material, including, for example, rubber, plastic, glass, ceramic, or a metal. The valve attachment point 108 can be formed of a material that facilitates coupling the valve system 106 to the balloon 102 during deployment and operation of the balloon 102.

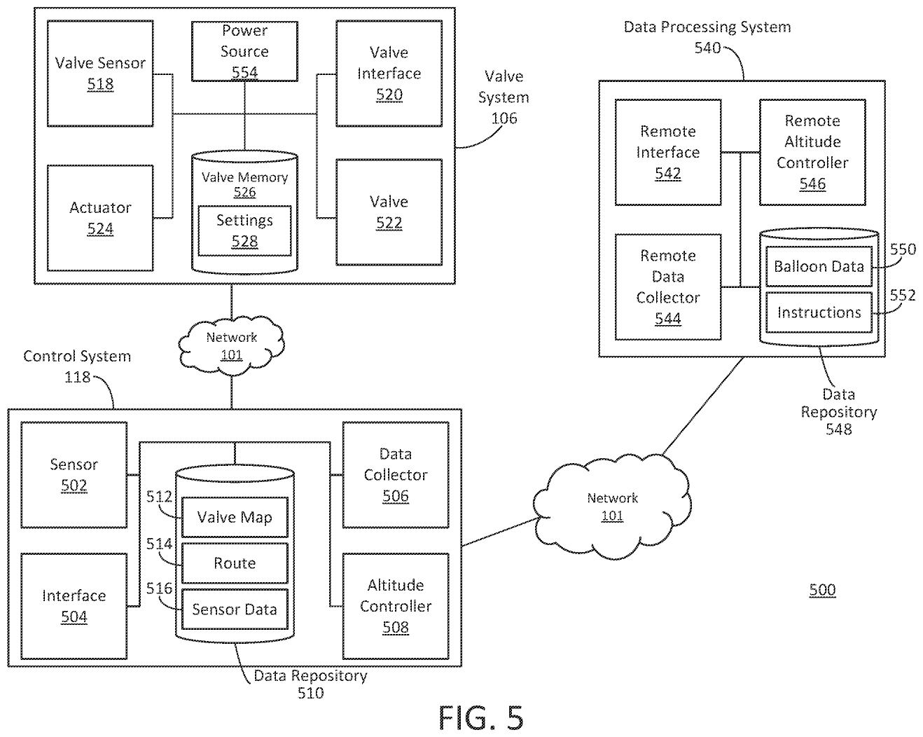

The system 100 can include a valve system 106. The valve system 106 can be coupled to the balloon 102 via the valve attachment point 108. The valve system 106 can vent the gas from within the balloon 102. The valve system 106 can include one or more component or functionality depicted in FIG. 5.

The balloon 102 can include a bottom portion 110. The bottom portion 110 can be opposite the top portion 104. The bottom portion 110 can have a shape based on the neck profile. The bottom portion 110 can be similar to the top portion 104, except for the location of the bottom portion 110 relative to the top portion 104. For example, when the balloon 102 is deployed or in operation, the bottom portion 110 can be closer to the surface of earth relative to the top portion 104. The bottom portion 110 can be closer to the gondola 116 relative to the top portion 104. The bottom portion 110 can refer to the portion of the balloon 102 that includes the cable attachment point 128 to tether the balloon 102 to the gondola 116.

The balloon 102 can be initially filled with the gas via the bottom portion 110. For example, the bottom portion 110 can include an opening through which a valve can be inserted. Gas can be injected or inserted into the balloon 102 via the bottom portion 110 and through the valve. Upon filling the balloon 102 with a desired amount of gas (e.g., volume or pressure), the bottom portion 110 can be sealed or closed so as to prevent or substantially prevent the release of gas through the bottom portion 110 of the balloon. The bottom portion 110 can be permanently sealed in such a manner that the control system 118 cannot vent gas through the bottom portion 110. The bottom portion 110 can be sealed using any sealing technique, including, for example, a sealant material, adhesive material, or otherwise tied off.

The bottom portion 110 can include a cable attachment point 128. A cable attachment point 128 can be located at the bottom portion 110. The cable attachment point 128 can include one or more hardware or mechanical component to that facilitates coupling the cable 112 to the balloon 102 during deployment or operation of the balloon 102. The cable attachment point 128 can be coupled or fixed to the balloon 102 via an adhesive material. The cable attachment point 128 can be built into the balloon 102. An example of hardware or a mechanism that can attach the cable to the balloon can include, for example, a cable tie. The cable attachment point can include a conductor that can communicate or convey electrical signals.

In an illustrative example, the length of the neck at the top portion 104 or bottom portion 110 can be 20 centimeters; the diameter of the neck at the top portion 104 or bottom portion 110 can be 5 centimeters. In an illustrative example, the height or diameter of the balloon 102 can be 1.5 meters at 0 km altitude (e.g., sea level or prior to any ascent); 2.5 meters at 12 km altitude (e.g., midway ascent); and 5 meters at 25 km altitude (e.g., full ascent).

The balloon 102 can be tethered to the gondola 116 via a cable 112. The cable 112 can include any type of cable, rope, chord, string, or tether. The cable 112 can be formed of, made of, or otherwise include one or more types of material. The cable 112 can be designed, constructed and operational to carry the weight of the gondola 116. The cable 112 can have a tear strength that is sufficient to hold, carry, or otherwise support the load of the gondola 116 without the cable 112 tearing or breaking. For example, the cable 112 can have a tear strength of 180 Newtons. The cable 112 can have a length, such as 5 meters, 10 meters, 15 meters, 20 meters, 25 meters, or more. The cable 112 can have a diameter, such as 1 mm, 2 mm, 3 mm, 4, mm or any other diameter.

The cable 112 can couple to the gondola 116 via a gondola attachment point 114. The gondola attachment point 114 can include any type of latch, ring, buckle, hook or other coupling mechanism. The gondola attachment point 114 can be secured to the gondola 116 or be a part of the gondola 116. For example, the gondola attachment point 114 can be screwed, bolted, nailed, or welded to the gondola 116. The gondola attachment point 114 can latched onto the gondola 116.

The cable 112 can be a passive cable that lacks or does not include the ability to provide electronic communications or electrical power between the gondola 116 and components of the balloon 102. In some cases, the cable 112 can be an active cable that includes an electrical wire that can provide electrical power or provide electrical communications between one or more components of the gondola 116 and one or more components of the gondola 116.

The balloon 102, when deployed, can ascent from the surface of earth towards an atmosphere of the earth. When doing so, the balloon 102 can carry a gondola 116 that is tethered to the balloon 102 via the cable 112. The gondola 116 can include one or more components or systems. For example, the gondola 116 can include at least one control system 118. The control system 118, an example of which is depicted in FIG. 5, can be designed, constructed and operational to control the venting of the valve system 106 in order to adjust the buoyancy of the system 100.

The gondola 116 can include at least one ballast tank 124. The ballast tank 124 can refer to or include any type of container that stores a material that is more dense than air. For example, the ballast tank 124 can store a liquid (e.g. water), sand, gravel, or a powder. The ballast tank 124 can include a ballast valve 126 that can release the material stored in the ballast tank 124. Releasing the material from the ballast tank 124 can increase the buoyancy of the system 100. The control system 118 can open the ballast valve 126 to release the material from the ballast tank 124 to increase the buoyancy of the system 100.

The gondola 116 can include a payload 120. The payload 120 can be any type of load to be carried by the system 100. The payload 120 can include cameras, sensors, probes or other instruments to perform an operation or function. The payload 120 can include instruments to take measurements associated with the system 100 or the atmosphere through which the system 100 traverses.

The gondola 116 can include landing gear 122. The landing gear 122 can include any type of landing gear suitable to absorb the force of impact from the ground when the system 100 lands or descents into the ground. The landing gear 122 can be configured for land or aquatic (e.g., sea, ocean, lake, pond, or river) landing. For example, the landing gear 122 can include legs, shock absorbers, wheels, flotation devices, pontoons, or an inflatable airbag.

The gondola 116 can include a power source 132 that stores electrical energy and provides electrical energy. The power source 132 can include a battery that can be electrically coupled to the control system 118 provide power to the electrical components of the control system 118, such as a sensor or altitude controller. The battery can provide power to other components of the gondola 116 or balloon 102, including, for example, a valve system 106, landing gear 122, or ballast valve 126. The battery can be any type of battery, including, for example, a lithium ion battery. In some cases, power source 132 can include solar panels or photovoltaic cells to convert solar energy to electrical energy to power electrical components of the system 100 (or system 200, 300, or 500).

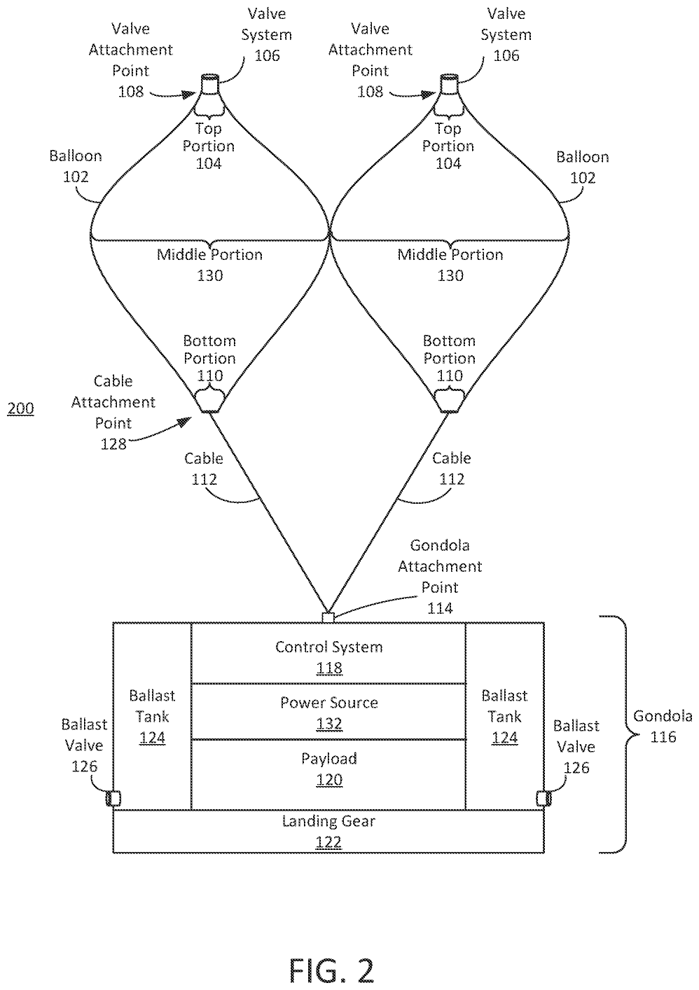

FIG. 2 illustrates a system 200 for balloon altitude control. The system 200 can include one or more component or system depicted in FIG. 1, including, for example, balloon 102, cable 112, and gondola 116. System 200 can include two or more balloons 102 that are attached to the same gondola 116 via the gondola attachment point 114. Each balloon 102 can be tethered to the gondola attachment point 114 via a respective cable 112. For example, a first balloon 102 can be tethered to the gondola attachment point 114 via a first cable 112, and a second balloon 102 can be tethered to the gondola attachment point 114 via second cable 112. A system 200 with more than one balloon 102 can provide increased buoyancy relative to a system with a single balloon 102. A system 200 with more than one balloon 102 can lift or carry a gondola 116 with a heavier payload 120 relative to a system 200 with fewer balloons 102. For example, the system 200 with two balloons can carry a heavier payload 120 as compared to a system 100 with a single balloon 102. The system 200 can include more than two balloons. For example, the system 200 can include three balloons 102, four balloons 102, five balloons 102, or more.

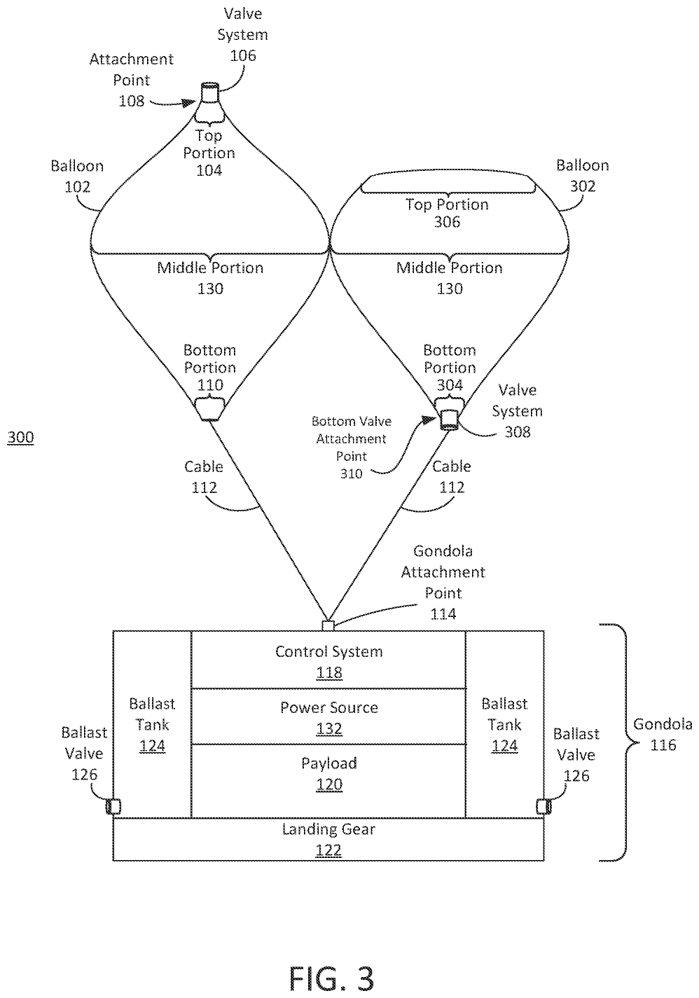

FIG. 3 illustrates a system 300 for balloon altitude control. The system 300 can include one or more component of system 100 depicted in FIG. 1, including for example balloon 102, gondola attachment point 114, and gondola 116. The system 300 can include a second balloon 302. The second balloon 302 can be different from the balloon 102 in that the second balloon 302 can include a valve system 308 that is located at the bottom portion 304 of the balloon 302. The valve system 308 can be located at the bottom portion 304, as opposed to the valve system 106 being located at the top portion 104 of the balloon 102. The valve system 308 can include one or more systems or components of valve system 106 depicted in FIG. 5. The valve system 308 can be the same as the valve system 106. The valve system 308 can be oriented to vent gas towards the gondola 116, whereas the vent system 106 can be oriented up to vent gas away from the gondola 116. In some cases, the valve system 308 can include a smaller valve or opening relative to the valve or opening of the valve system 106. The valve system 308 can include a smaller valve or opening because the rate at which a lighter than air gas is vented from the bottom portion 304 can be slower than the rate at which the lighter than air gas is vented from the top portion 104. The ballast valve 126 can be controlled by one or more component or function of a valve system 106. Thus, the valve system 106 can actuate a balloon valve or a ballast tank valve.

The bottom portion 304 of the balloon 302, which can be closer to the gondola 116 or surface of the earth relative to the top portion 306 of the balloon 302, can have a shape based on a neck profile. For example, the bottom portion 304 can be shaped similar to the bottom portion 110 of the balloon 102. However, the top portion 306 of the balloon 302 can have a different shape than the top portion 104 of the balloon 102. For example, the top portion 306 of the balloon 302 can have a rounded shape or profile that does not resemble a neck profile. The top portion 306 can have the rounded shape or profile because the top portion 306 may not include a top valve system 106, as in balloon 102. Since the top portion 306 of balloon 302 does not include a valve system, the top portion 306 of balloon 302 can have the same thickness as the middle portion 130 of balloon 302. The material at the bottom portion 304 of the balloon 302 can be thicker than the material at the top portion 306. The material can be latex, and the balloon 302 can be filled with the same gas as balloon 102.

The balloon 302 can include a bottom valve attachment point 310. The bottom valve attachment can include one or more component or functionality of the attachment point 108 located at the top portion 104 of balloon 102. The bottom valve attachment point 310 can couple the valve system 308 to the bottom portion 304 of the balloon 302.

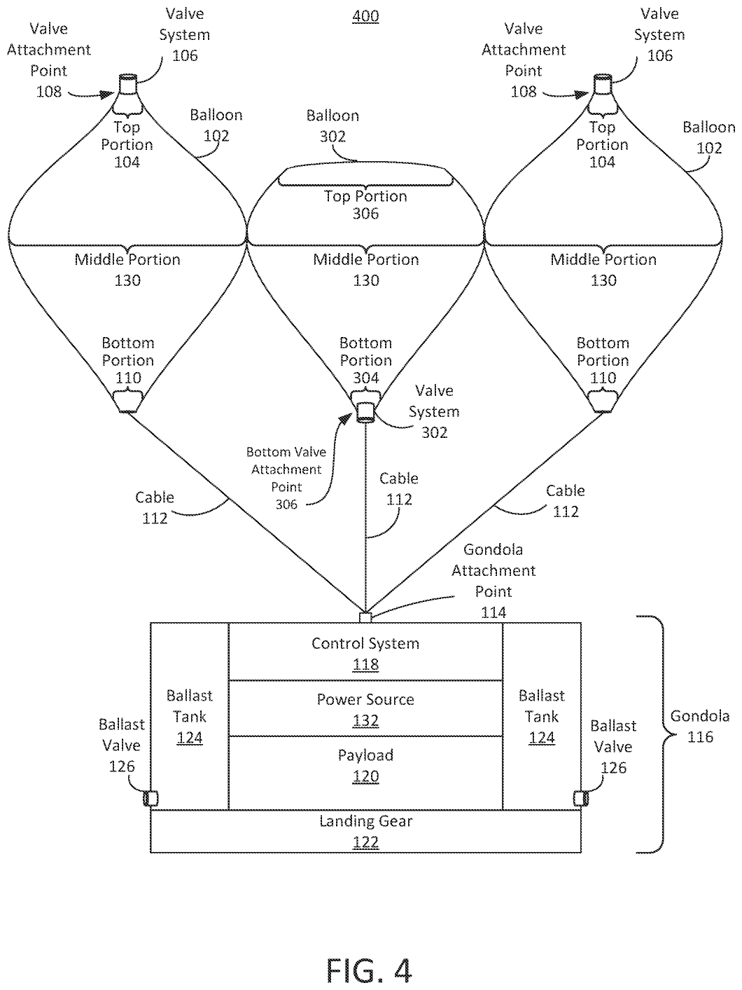

FIG. 4 illustrates a system 400 for balloon altitude control. The system 400 can include one or more system or component depicted in FIG. 1 or FIG. 3, including for example balloon 102, balloon 302, and gondola 116. The system 400 can include one or more balloons 102 and one or more balloons 302. For example, the system 400 can include two balloons 102 with valve systems 106 located at the top portion 104 of the respective balloons 102, and one balloon 302 with a valve system 308 located at the bottom portion 304. The system 400 can include a cluster of balloons that includes at least three balloons (e.g. a first balloon 102, a second balloon 102, and a third balloon 302). The cluster of balloons 102 can include any number and type (e.g. top valve or bottom valve) of balloons.

System 400 can include one or more top valve systems 106 and one or more bottom valve systems 308. In some cases, a single balloon can include both a top valve system 106 and a bottom valve system 308. For example, the balloon 102 can include a valve system 106 at the top portion 104, and a valve system 308 at the bottom portion 110. The control system 118 can store a valve map 512 that includes information about whether the balloons 102 and 302 have a top valve or bottom valve in order to coordinate rapid descent via top valves, or a slower, controlled descent via bottom valves. For example, a first valve at the top portion 104 of the balloon 102 can release the gas from within the balloon 102 at a greater rate than a second valve located at a bottom portion 304 of a second balloon 302 releases the gas from within the second balloon 302.

FIG. 5 is a system 500 for balloon altitude control. The system 500 can include a control system 118 that can communicate with a valve system 106 via network 101 to provide an instruction or command to open or close the valve 522. The system 500 can include the valve system 106 to receive the command from the control system 118, and open the valve 522 to release or vent a gas from within a balloon. The system can include, interface with or otherwise communicate with a data processing system 540 via network 101. The data processing system 540 can communicate with one or more of the control system 118 or the valve system 106 via network 101. In some cases, the data processing system 540 can communicate with the valve system 106 via the control system 118.

The network 101 can include computer networks such as the Internet, local, wide, metro, or other area networks, intranets, cellular networks, satellite networks, and other communication networks such as voice or data mobile telephone networks. The network 101 can be used to communicate or transmit data between two or more of the control system 118, valve system 106 and the data processing system 540. For example, the control system 118 can receive data from the valve sensor 518 via network 101. The control system 118 can transmit commands or instructions to the valve system 106 via network 101. The control system 118 can establish a communication channel with the valve system 106 via network 101. The control system 118 can communicate or exchange data with the data processing system 540 via network 101. The data can include, for example, sensor data 516, instructions 552, or other information.

The network 101 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 101 may include a wireless link, such as an infrared channel or satellite band. The topology of the network 101 may include a bus, star, or ring network topology. The network may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data may be transmitted via different protocols, or the same types of data may be transmitted via different protocols.

The system 500 can include, interface with, communicate, or otherwise access a valve system 106. The valve system 106 can include at least one logic device such as a computing device having a processor to communicate via the network 101, for example with the control system 118 or data processing system 540. The valve system 106 can include at least one computation resource, server, processor or memory.

The valve system 106 can be attached or coupled to a balloon 102, for example. In brief overview, the valve system 106 can include at least one valve sensor 518 to detect, measure, or otherwise identify characteristics or attributes of the valve system 106, balloon 102, or the environment around the balloon. The valve system 106 can include at least one valve interface 520 to communicate with or receive instructions from the control system 118 via network 101. The valve system 106 can include a valve 522 to open to release or vent gas from within the balloon 102, or close to prevent or substantially prevent the gas from escaping from the balloon. The valve system 106 can include at least one actuator 524 that can receive a signal from the valve interface 520 and actuate the valve 522 to open or close the valve 522. The valve system 106 can include a valve memory 526 to store scripts, programs, rules, or instructions. The valve memory 526 can store one or more data structures or files. The valve memory 526 can store or buffer data collected by the valve sensor 518. The valve memory can store settings 528, which can include information about the valve 522 configuration (e.g., a balloon top valve, a balloon bottom valve, a ballast valve, or size of the valve).

The valve sensor 518, valve interface 520, or actuator 524 can each include at least one processing unit or other logic device such as programmable logic array engine, or module configured to communicate with the valve memory 526. The valve sensor 518, valve interface 520, or actuator 524 can be separate components, a single component, or part of the valve system 106. The valve system 106 and its components can include hardware elements, such as one or more processors, logic devices, or circuits.

The valve sensor 518 can include any type of sensor that can facilitate operating a valve, controlling buoyancy of a balloon, or measuring characteristics of the environment proximate to the balloon. Example valve sensors 518 can include an air flow rate sensor configured to detect, measure, or otherwise sensor or identify the rate of air or gas flowing out of the valve 522. The valve sensors 518 can include a sensor that can detect whether the valve 522 is open or closed, or the percentage or amount the valve is open or closed (e.g., 10% open, 20% open, 30% open, 50% open). The valve sensor 518 can include a pressure sensor that can measure the pressure at the valve 522 or within the balloon 102. The valve sensor 518 can include a temperature sensor or humidity sensor.

The valve system 106 can include at least one valve interface 520 designed, constructed and operational to communicate with the control system 118 or the data processing system 540 via network 101. The valve interface 520 can include a hardware interface, software interface, wired interface, or wireless interface. The valve interface 520 can facilitate communication between one or more components of the valve system 106. The valve interface 520 can include any type of communication interface or port that can allow for communications between the valve system 106 and the control system 118. The valve interface 520 can include a network interface, hardware interface, wired interface, or wireless interface. The valve interface 520 can include any type of interface configured to communicate over network 101 with control system 118. The valve interface 520 can receive input instructions, commands, queries or requests from the control system 118. The valve interface 520 can output status information, collected data, sensor data or other information to the control system 118. The valve interface 520 can receive settings or programs to update a system or component of the valve system 106.

The valve system 106 can include a valve 522. The valve 522 can include a balloon valve to open to release or vent gas from within the balloon 102, or close to prevent or substantially prevent the gas from escaping from the balloon. The valve 522 can be a ballast valve 126 to open to release a material from within the ballast tank, and close to prevent the release of the material from within the ballast tank. The valve 522 can be any type of valve that can close to prevent gas from being released or vented from the balloon, and close to vent or release gas from the balloon. Types of valves 522 can include, for example, a ball valve, a gate valve, a solenoid valve, butterfly valve, gate valve, plug valve, or diaphragm valve. The valve 522 can be inserted into the open end at the top portion 104 of the balloon 102, or the open end at the bottom portion 304 of the balloon 302. The valve 522 can open to release gas from within the balloon, and close to at least partially prevent the release of the gas from within the balloon. For example, the valve 522 can close 5%, 10%, 20%, 30%, 40%, 50% or some other percentage to vent the gas from the balloon at a rate that is less than the rate of venting if the valve is open 100%. This can allow for a controlled descent of the balloon.

In some cases, the valve, when 100% closed, may allow a portion of gas to vent. For example, the valve 522, when closed, may not provide an airtight seal at all pressure levels. For example, if the pressure within the balloon exceeds a threshold, then the valve 522, even when closed, may allow gas to vent until the pressure within the balloon drops to the threshold or below the threshold in order to prevent the balloon from bursting or otherwise being damaged. In some cases, a valve sensor 518 can sense the pressure and then trigger the actuator 524 or a component of the control system 118 to open the valve 522 to vent at least a portion of the gas to reduce the pressure within the balloon.

The valve system 106 can include an actuator designed, constructed and operational to receive a command via the valve interface 520, and open or close (or at least partially open or close) the valve 522 responsive to, based on, or otherwise in accordance with the command or instruction. The actuator 524 can include any type of actuator, such as an electromechanical actuator, motor-driven actuator, magnetic actuator, or electromagnetic actuator. The actuator 524 can include a mechanical device that can move or control the valve 522. The actuator 524 can include a rotary valve actuator, linear valve actuator, pneumatic actuator. The actuator 524 or valve 522 can include a spring return that can push the valve 522 to a default position (e.g., closed) after being actuated.

The valve system 106 can include a power source 554, such as a battery, to store electrical energy and provide electrical energy or power for one or more electrical components of the valve system 106. The power source 554 can be a lithium ion battery or any other type of battery. The power source 554 can include solar panels, for example. In some cases, the valve system 106 may not include or lack a power source 554. Instead, the valve system 106 can receive electrical power from power source 132 located on the gondola 116 and via a cable 112.

The system 500 can include, interface with, or otherwise access a control system 118. The control system 118 can include at least one logic device such as a computing device having a processor to communicate via the network 101, for example with the valve system 106 or data processing system 540. The control system 118 can include at least one computation resource, server, processor or memory. The control system 118 can include at least one sensor 502 to sense, detect, measure or otherwise capture information associated with or the balloon operation. The control system 118 can include at least one interface 504 to communicate with the valve system 106 or data processing system 540 via network 101. The control system 118 can include at least one data collector 506 to collect or store data from the sensor 502 or valve sensor 518. The control system 118 can include at least altitude controller 508 to provide an instruction to the valve system 106 to open or close the valve 522. The control system 118 can include a data repository 510 to store one or more data structures, files, instructions or other data. For example, the data repository 510 can store a valve map 512 that includes information used to identify a valve of a balloon, a location of the valve (e.g., top valve or bottom valve), or other settings for the valve. The valve map 512 can store an indication that a first valve is located at a top portion of the balloon and a second valve is located at a bottom portion of a second balloon. The data repository 510 can store a route 514 for the operation of the balloon. The route 514 can refer to altitudes the balloon is to traverse or reach throughout an operation. The route 514 can include a target altitude for a time period. For example, the route 514 can indicate a duration for which to remain at an altitude or to perform an ascent or descent operation. The sensor data 516 can include data collected by sensor 502 or valve sensor 518.

The sensor 502, interface 504, data collector 506, or altitude controller 508 can each include at least one processing unit or other logic device such as programmable logic array engine, or module configured to communicate with the data repository 510 or database. The sensor 502, interface 504, data collector 506, or altitude controller 508 can be separate components, a single component, or part of the control system 118. The control system 118 and its components can include hardware elements, such as one or more processors, logic devices, or circuits.

The control system 118 can include, interface, or otherwise access at least one sensor 502. The sensor 502 can include, for example, an altitude sensor, pressure sensor, temperature sensor, humidity, location sensor, global positioning system sensor, wind speed sensor, wind direction sensor, wind velocity sensor, light sensor, or proximity sensor. The sensor 502 can include image sensors, a camera, or a video camera. The sensor 502 can include a visual spectrum light sensor, infrared light sensor, ultraviolet light sensor or a sensor tuned to another spectrum of electromagnetic waves. The sensor 502 can include an acoustic sensor, a sound sensor, or an ultrasonic sensor, such as a microphone or transducer. The sensor 502 can include a particle sensor to sense or detect the amount of a type of particle present in the atmosphere, such as carbon dioxide, oxygen, nitrogen, ozone, or other gas or particle.

The sensor 502 can interface with the data collector 506 to collect the sensed data and store the sensor data 516 in data repository 510. The sensor 502 can provide a time stamp associated with a sensed measurement, detection or other metric. The sensor 502 can sense a condition such as temperature, altitude, or position, at a predetermined rate or frequency. For example, the sensor 502 can detect or measure the altitude at 0.25 Hz, 0.5 Hz, 1 Hz, 2 Hz, 3 Hz, or other frequency. In some cases, the sensor 502 can take an observation responsive to an instruction or indication from the data collector 506.

The control system 118 can include a data collector 506 designed, constructed and operational to receive data sensed by the sensor 502. The data collector 506 can receive data from one or more sensors 502. The data collector 506 can receive a stream or feed of data collected by sensor 502. The data collector 506 can receive data samples or observations from the sensor 502. The data collector 506 can ping, poll or otherwise request data from sensor 502. The data collector 506 can request data from sensor 502 at a predetermined interval, frequency, rate, or responsive to a condition or event. For example, the data collector 506 can obtain a temperature reading after every 10 meter change in altitude. The data collector 506 can assign a timestamp to each data sample or observation made or received from the sensor 502. For example, the data collector 506 can include a counter or clock that tracks the passage of time and assigns a timestamp or counter value to the time stamp.

The data collector 506 can store the data as sensor data 516 in data repository 510. The data collector 506 can store the sensor data 516 as a table or other type of data structure. Table 1 illustrates an example data structure or table of sensor data 516.

TABLE 1
Illustrative example of sensor data 516

| | | | | Valve_1 |
|---|---|---|---|---|
| Time stamp | Temperature | Altitude | Location | Position |
| 12:00:00 | 40 F. | 1000 m | Lat_Long_1 | Open |
| 12:00:02 | 40 F. | 1005 m | Lat_Long_2 | Open |

As illustrated in Table 1, the sensor data 516 can include a column with time stamps, a column with temperature measurements, a column with altitude measurements, a column with location readings, and a column that indicates the position of a valve. The temperature, altitude or location can be sensed by a sensor 502 of the control system 118, for example. The valve position can be sensed from valve sensor 518 of the valve system 106.

The control system 118 can include an interface 504 designed, constructed or operational to communicate or exchange data or instructions via network 101 to valve system 106 or data processing system 540. The interface 504 can include a hardware interface, software interface, wired interface, or wireless interface. The interface 504 can facilitate communication between one or more components of the control system 118. The interface 504 can include any type of communication interface or port that can allow for communications between the control system 118 and the valve system 106 or data processing system 540. The interface 504 can include a network interface, hardware interface, wired interface, or wireless interface. The interface 504 can include any type of interface configured to communicate over network 101 with valve system 106 or data processing system 540. The interface 504 can receive input instructions, commands, queries or requests from the data processing system 540. The interface 504 can output status information, collected data, sensor data or other information to the data processing system 540. The interface 504 can receive settings or programs to update a system or component of the control system 118. For example, the interface 504 can receive route information 514, a valve map 512, or sensor data 516 via interface 504.

In some cases, the interface 504 can provide a user interface, graphical user interface, or frontend user interface. The interface 504 can receive user input via an input device 830, for example.

For example, the interface 504 (e.g. a second wireless interface card) can establish a wireless communication channel with the valve interface 520 (e.g. a first wireless interface card) via network 101. The control system 118 can transmit, via the wireless communication channel, a signal to command the actuator 524 to open the valve 522 to release the gas via a top portion of a balloon, for example.

The control system 118 can include an altitude controller 508 designed, constructed and operational to provide a signal or command to the valve system 106 to open or close the valve 522. The altitude controller 508 can provide the command to open the valve 522 to release gas from within a balloon (e.g., balloon 102 or balloon 302) responsive to a determination to decrease buoyancy of the system 100, system 200, system 300, or system 400, for example. The altitude controller 508 can provide for a greater dynamic range of altitude control. For example, the altitude controller can open all valves in a balloon system (e.g. top and bottom valves) while closing all ballast tank valves to provide a maximum rate of descent or maximum decrease in buoyancy. The altitude controller 508 can control the altitude at a granular level by selecting top and bottom valves to open in conjunction with ballast tank valves. Opening a ballast tank valve can increase buoyancy by at least partially cancelling out a portion of the decrease in buoyancy caused by opening a valve.

The altitude controller 508 can determine to open or close a valve 522 of a balloon. The altitude controller 508 can determine to open or close the valve 522 based on one or more techniques, programs, or responsive to an event or condition. The altitude controller 508 can determine to adjust the buoyancy based on one or more techniques, programs or responsive to an event or conduction, and then adjust either a valve of a balloon or a valve of a ballast tank in order to increase or decrease the buoyancy based on the determination. The altitude controller 508 can determine whether to open one or more top valves, one or more bottom valves, or both top valves and bottom valves based on the determination. For example, the altitude controller 508 can determine that a high rate of descent is desired, and then determine to open the top valves and the bottom valves in the system to provide a higher rate of descent or the highest rate of descent possible in the system. The altitude controller 508 can determine to open one or more bottom valves if a slower, more controlled rate of descent is desired. For example, the altitude controller 508 can determine to adjust buoyancy, or open or close one or more valves based on a time-based schedule, responsive to a condition or event, based on a route, based on an amount of data collected, or responsive to an instruction from a data processing system 540.

For example, the altitude controller 508 can determine to open or close one or more valves based on a time-based schedule. The data repository 510 can store a schedule with time stamps that indicate when to open a valve. The schedule can include an indication of the time stamp relative to the start time of the balloon operation (e.g. when the balloon begins an ascent or departure from the ground). The schedule can include an indication of a valve identifier, a time stamp, and a state of the valve for the time stamp. An example schedule is illustrated in Table 2:

TABLE 2
Illustrative time-based schedule for controlling valves

| | Top_Valve_1 | Bottom_Valve_2 | Top_Valve_3 | Ballast |
|---|---|---|---|---|
| Time stamp | State | State | State | Tank Valve |
| 12:00:00 | Close | Close | Close | Open 25% |
| 12:30:00 | Open 100% | Open 100% | Open 100% | Close |
| 12:31:00 | Open 50% | Open 100% | Close 50% | Close |
| 12:32:00 | Open 25% | Open 100% | Close 25% | Close |

As illustrated in Table 2, the example schedule can include a time stamp and a corresponding state of each valve at the time stamp. The altitude controller 508 can parse the schedule and generate commands in accordance with the schedule. At time stamp 12:00:00, or the beginning of the operation, the altitude controller 508 can keep the gas valves closed, but open the ballast tank valve 25% so as to increase the buoyancy of the system (e.g., system 400) to facilitate ascension of the system. The altitude controller 508 can send a command to Top_Valve_1 (e.g., via a valve interface 520), which can refer to a valve located at a top portion of a first balloon 102, to open 100% at time 12:30:00. The altitude controller 508 can send a command to Bottom_Valve_2 (e.g., via a valve interface 520), which can refer to a valve located at a bottom portion of balloon 302, to open 100% at time 12:30:00. The altitude controller 508 can send a command to Top_Valve_3 (e.g., via a valve interface 520), which can refer to a valve located at a top portion of a second balloon 102, to open 100% at time 12:30:00. The altitude controller 508 can further send commands to open 50% or open 25% in accordance with the schedule.

The schedule can be programmed by a user or administrator of control system 118. The schedule can be loaded onto control system 118 via data processing system 540, such as via network 101.

The altitude controller 508 can determine to open or close a valve (e.g., gas valve or ballast tank valve) responsive to a condition sensed by a sensor 502 or valve sensor 518. For example, the altitude controller 508 can be programmed to decrease buoyancy responsive to an altitude threshold. The sensor 502 can measure a current altitude of the system 118. The altitude controller 508 can compare the current altitude of the system 118 with a desired altitude for the system. If the current altitude exceeds the desired altitude, the altitude controller 508 can determine to decrease the buoyancy of the system 118 by opening one or more valves of the system. Thus, the altitude controller 508 can determine, based on the comparison of the current altitude with the desired altitude, to decrease the buoyancy of the system.

The altitude controller 508 can determine to decrease the buoyancy of the system if the rate of ascension is greater than a threshold. For example, if the rate of ascension is greater than 5 meters a second or 10 meters a second, the altitude controller 508 can determine to open one or more valves in order to reduce the rate of ascension.

The altitude controller 508 can determine to open or close a valve based on other conditions, such as pressure within the balloon, temperature, precipitation, or wind conditions.

The altitude controller 508 can determine the rate at which to decrease the buoyancy. The rate can be a predetermined rate, a fixed rate, a dynamically computed rate, or a rate level. A rate level can be on scale, such as 1 to 5, where 5 can be the maximum rate of decrease of buoyancy, and 1 can be a minimum rate of decrease of buoyancy. For example, the altitude controller can determine to decrease the rate of buoyancy at a rate level of 5. Responsive to this determination, the altitude controller 508 can command all valves, both top valves and bottom valves, to open. For rate levels 2-5, the altitude controller 508 can determine a combination of one or more bottom valves and top valves to open. For rate level 1, the altitude controller 508 can determine to close top valves and open bottom valves, for example. Thus, by having both top and bottom valves in a system (e.g., system 400), the altitude controller 508 can decrease buoyancy faster than a system that lacks top valves, while maintaining the ability to control the decrease in buoyancy via the bottom valves.

The altitude controller 508 can adjust buoyancy based on a route 514. The route 514 can include a latitude and longitude position and a corresponding desired altitude. The route 514 can include a geographical fence or boundary within which to keep the balloon at a certain altitude or within which to land the balloon. If the current altitude is less than or greater than the desired altitude for the identified latitude and longitude coordinate, then the altitude controller 508 can increase or decrease buoyancy accordingly. If the delta between the current altitude and desired altitude is greater than a threshold, and the determination is to decrease the buoyancy, the altitude controller 508 can select top valves and bottom valves to open in order to decrease the buoyancy at a faster rate. If the delta is less than the threshold, and a finer adjustment is desired, the altitude controller 508 can open bottom valves and close the top valves because top valves vent the gas at a greater rate than the bottom valves.

In some cases, the altitude controller 508 can determine to decrease the buoyancy based on satisfying a data collection performance metric. For example, if the data collector 506 has collected a desired number of images, or other data samples, then the data collector 506 can instruct the altitude controller 508 to terminate the balloon operation and land the balloon. The altitude controller 508 can, responsive to the determination to land the balloon, open top valves and bottom valves to expedite landing.

The altitude controller 508 can receive an instruction or command from the data processing system 540 via network 101. The altitude controller 508 can forward the command to the valve system 106 to adjust the buoyancy accordingly. For example, the control system 118 can receive, from a data processing system 540 remote from the system, an instruction to at least one of decrease the buoyancy of the system or open the first valve. The altitude controller 508 can provide, responsive to the instruction received from the data processing system 540, a signal to command the actuator 524 to open a valve. The altitude controller 508 can open one or more valves or one or more types of valves based on the instruction.

For example, the instruction can be to open only top valves, open only bottom valves, open all valves, or open some other combination of top and bottom valves. Responsive to the instructions, the altitude controller can perform a lookup in the valve map 512 data structure to obtain identifiers for top valves of balloons that are tethered to the gondola in which the control system resides. The altitude controller 508 can then provide a signal to the identified top valves to open.

In some cases, the altitude controller can determine to open a ballast valve of a ballast tank to release a material from within the ballast tank responsive to a determination to increase the buoyancy of the system. Thus, open determining which valves to open, the altitude controller 508 can perform a lookup in the valve map 512 data structure to identify a state of the respective valve, an identifier of the valve, and then use the state information and identifier (e.g., a communication identifier or network address) in order to transmit an instruction to open or close to the corresponding valve.

The system 500 can include at least one data processing system 540. The data processing system 540 can include at least one logic device such as a computing device having a processor to communicate via the network 101, for example with the control system 118. The data processing system 540 can include at least one computation resource, server, processor or memory. For example, the data processing system 540 can include a plurality of computation resources or servers located in at least one data center. The data processing system 540 can include multiple, logically-grouped servers and facilitate distributed computing techniques. The logical group of servers may be referred to as a data center, server farm or a machine farm. The servers can also be geographically dispersed. A data center or machine farm may be administered as a single entity, or the machine farm can include a plurality of machine farms. The servers within each machine farm can be heterogeneous—one or more of the servers or machines can operate according to one or more type of operating system platform.

Servers in the machine farm can be stored in high-density rack systems, along with associated storage systems, and located in an enterprise data center. For example, consolidating the servers in this way may improve system manageability, data security, the physical security of the system, and system performance by locating servers and high performance storage systems on localized high performance networks. Centralization of all or some of the data processing system 540 components, including servers and storage systems, and coupling them with advanced system management tools allows more efficient use of server resources, which saves power and processing requirements and reduces bandwidth usage.

The data processing system 540 can include, interface, or otherwise communicate with at least one remote interface 542. The data processing system 540 can include, interface with, or otherwise communicate with at least one remote data collector 544. The data processing system 540 can include, interface with, or otherwise communicate with at least one remote altitude controller 546. The data processing system 540 can include, interface with, or otherwise communicate with at least one data repository 548. The data repository 548 can include, store or maintain balloon data 550 or instructions 552. Balloon data 550 can include data collected by a valve sensor 518, sensor 502, or data collector 506. Balloon data 550 can include data stored in valve memory 526 or data stored in data repository 510. The instructions 552 can include instructions to command the control system 118 or valve system 106, such as to open or close valves, increase or decrease buoyancy, or provide valve map or route information.

The remote interface 542, remote data collector 544, and remote altitude controller 546 can each include at least one processing unit or other logic device such as programmable logic array engine, or module configured to communicate with the database repository 548 or database. The remote interface 542, remote data collector 544, and remote altitude controller 546 can be separate components, a single component, or part of the data processing system 540. The data processing system 540 and its components can include hardware elements, such as one or more processors, logic devices, or circuits.

The data processing system 540 can include a remote interface 542 designed, configured, constructed, or operational to communicate with interface 504 of control system 118 or valve interface 520 of valve system 106 via network 101. The remote interface 542 can include a hardware interface, software interface, wired interface, or wireless interface. The remote interface 542 can facilitate communication between one or more components of the data processing system 540.

The remote interface 542 can include or provide a user interface, such as a graphical user interface or frontend user interface. The remote interface 542 can provide the user interface or access to a frontend interface via a client computing device. The remote interface 542 can receive input via an input device 830. The remote interface 542 can provide output for presentation via a display 835.

The data processing system 540 can include a remote data collector 544 designed, constructed, and operational to receive data from control system 118 via network 101. The data collector 544 can receive data from valve interface 520 via network 101. The remote data collector 544 can include one or more component or functionality of data collector 506. The remote data collector 544 can receive a data stream from control system 118 that includes, for example, sensor data 516 or other data obtain by data collector 506. In some cases, the remote data collector 544 can request data from the control system 118. The data collector 506 can provide data to the data processing system 540 responsive to the request. The data collector 506 can provide data as a batch upload (e.g., once every 5 minutes, 10 minutes, 20 minutes, 30 minutes, 1 hour, or other time interval).

The data processing system 540 can include a remote altitude controller 546 designed, constructed, and operational to cause a valve to open or close. The remote altitude controller 546 can include one or more component or functionality of altitude controller 508. The remote altitude controller 546 can receive input from an input device 830 and send instructions to the control system 118 responsive to the input. For example, a user of the data processing system 540 can indicate to land the balloon. The data processing system 540 can generate and transmit instructions to the control system 118 to control system 118 to instruct the valve system 106 to decrease buoyancy in order to land the balloon or cluster of balloons of system 100, 200, 300 or 400, for example.

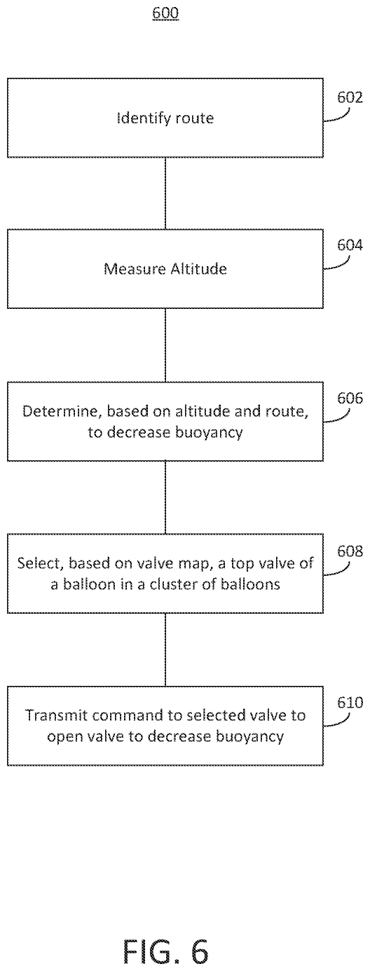

FIG. 6 is an illustration of an example method 600 for balloon altitude control. The method 600 can be performed by one or more system or component depicted in FIGS. 1-5 or FIG. 8, including, for example, a control system or valve system. For example, the method 600 can be performed by a system 400 that includes a cluster of balloons 102 and 302. At ACT 602, the method can include the control system identifying a route. The route can be stored in memory of the control system. The route can include information about a location, such as a geographic location defined by latitude and longitude coordinates, a geofence, or an altitude. The route can include altitude or location-based information that is associated. The route can include information used to determine whether to decrease or increase buoyancy of a balloon system 100, for example. The route can indicate to land the balloon system based on entering or leaving a geofence. The route can indicate to decrease the altitude of the balloon system based on reaching an altitude threshold. The route can indicate to maintain the balloon system at a predetermined altitude range within a predetermined location range.

At ACT 604, the control system can measure the current altitude of the balloon system. The control system can determine or measure the current altitude using a sensor, such as an altimeter. The control system can ping the altimeter to determine a current altitude reading, for example. The control system can make other measurements via one or more other sensors, including, for example, location measurements, temperature measurements, or pressure measurements.

At ACT 606, the control system can determine, based on the altitude and the route, to decrease the buoyancy for the balloon system. For example, the control system can determine, from the route, that the desired or target altitude for the balloon system is lower than the current altitude for the current location. In another example, the control system can determine to land the balloon system based on the current location, which can entail decreasing the buoyancy of the balloon system.

At ACT 608, the control system can select, based on a valve map, a top valve of a balloon in a cluster of balloons to open. The control system can perform a lookup on a valve map or otherwise query a valve map to identify the types of valves that are in the cluster of balloons tethered to the control system. The control system can determine to decrease the buoyancy at a high rate in order to increase the rate of descent. For example, if the control system determines based on the route, to land the balloon system, then the control system can select the top valves (or both top valves and bottom valves) in the valve map in order to cause the fastest rate of descent of the balloon system. If the control system determines, based on the route, to maintain the altitude of the balloon or only slightly decrease the altitude of the balloon system (e.g., by 5 meters, 10 meters, 15 meters or other amount that is facilitated by a more controlled venting of the gas relative to a top valve), then the control system can select a bottom valve.

At ACT 610, the control system can transmit a command to the selected valve to open the valve to decrease the buoyancy. The control system, via the valve map, can obtain an identifier of the valve and can send a wired or wireless signal to the corresponding valve system of the valve to cause the valve system to actuate the valve to open the valve to vent the gas.

The signal can include an instruction as to the duration to keep the valve open, such as 5 seconds, 10 seconds, 20 seconds, 30 seconds, 1 minute, 2 minutes, 3 minutes or more. The duration to keep the valve open can be based on detecting a subsequent condition, such as reaching a desired altitude or landing. The duration can be based on whether the valve is a top valve or a bottom valve due to the different vent rates at the top and bottom.

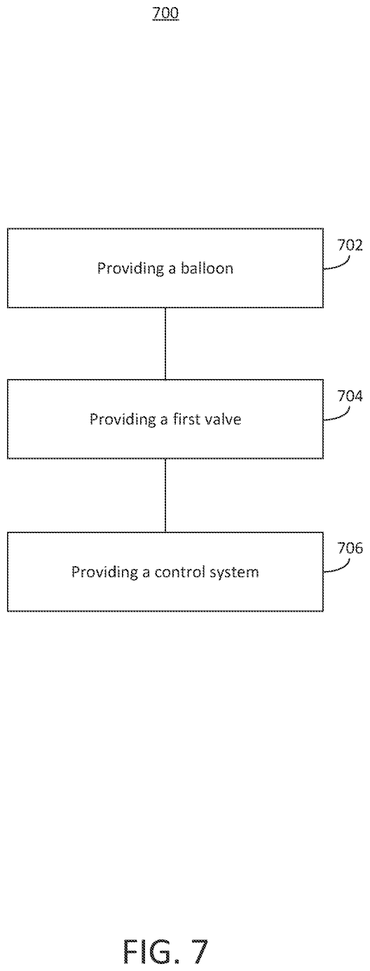

FIG. 7 is an illustration of an example method 700 for balloon altitude control. The method 700 can be performed by one or more system or component depicted in FIGS. 1-5 or FIG. 8, including, for example, a control system or valve system. For example, the method 700 can be performed by a system 100, 200, 300, or 400 that includes one or more balloons and control system. At ACT 702, the method can include providing a balloon. The balloon can include a top neck with a top valve, such as a balloon 102 depicted in FIG. 1. At ACT 704, the method can include providing a first valve, such as a valve 522 depicted in FIG. 5 which can be part of a valve system 106 depicted in FIG. 1. In some cases, providing a valve can include or be referred to as providing a valve system. At ACT 706, the method can include providing a control system, such as the control system depicted in FIG. 1 or FIG. 5, for example.

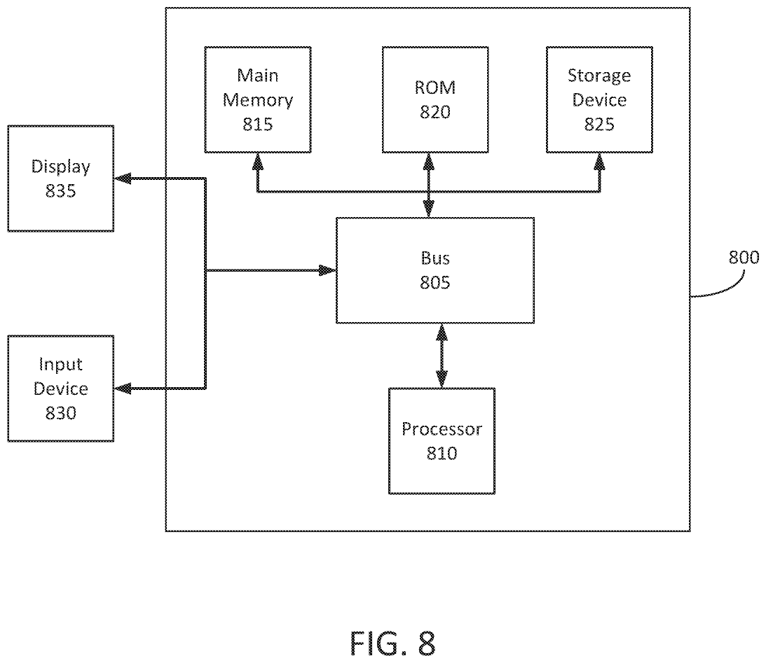

FIG. 8 is a block diagram of an example computer system 800. The computer system or computing device 800 can include or be used to implement the system 100, 200, system 300, system 400, system 500, or its components such as the control system 118, valve system 106, or data processing system 540. The computing system 800 can be used to implement the method 600 or method 700. The computing system 800 includes a bus 805 or other communication component for communicating information and a processor 810 or processing circuit coupled to the bus 805 for processing information. The computing system 800 can also include one or more processors 810 or processing circuits coupled to the bus for processing information. The computing system 800 also includes main memory 815, such as a random access memory (RAM) or other dynamic storage device, coupled to the bus 805 for storing information, and instructions to be executed by the processor 810. The main memory 815 can be or include the data repository 510 or data repository 548. The main memory 815 can also be used for storing position information, temporary variables, or other intermediate information during execution of instructions by the processor 810. The computing system 800 may further include a read only memory (ROM) 820 or other static storage device coupled to the bus 805 for storing static information and instructions for the processor 810. A storage device 825, such as a solid state device, magnetic disk or optical disk, can be coupled to the bus 805 to persistently store information and instructions. The storage device 825 can include or be part of the data repository 510 or 548.

The computing system 800 may be coupled via the bus 805 to a display 835, such as a liquid crystal display, or active matrix display, for displaying information to a user. An input device 830, such as a keyboard including alphanumeric and other keys, may be coupled to the bus 805 for communicating information and command selections to the processor 810. The input device 830 can include a touch screen display 835. The input device 830 can also include a cursor control, such as a mouse, a trackball, or cursor direction keys, for communicating direction information and command selections to the processor 810 and for controlling cursor movement on the display 835. The display 835 can be part of the data processing system 540, the control system 118 or other component of FIGS. 1-5, for example.

The processes, systems and methods described herein can be implemented by the computing system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computing system 800 to perform the illustrative processes described herein. One or more processors in a multi-processing arrangement may also be employed to execute the instructions contained in main memory 815. Hard-wired circuitry can be used in place of or in combination with software instructions together with the systems and methods described herein. Systems and methods described herein are not limited to any specific combination of hardware circuitry and software.

Although an example computing system has been described in FIG. 8, the subject matter including the operations described in this specification can be implemented in other types of digital electronic circuitry, or in computer software, firmware, or hardware, including the structures disclosed in this specification and their structural equivalents, or in combinations of one or more of them.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “control system”, “valve system”, “data processing system” “computing device” “component” or “data processing apparatus” can encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. For example, the remote data collector 544, remote altitude controller 546 and other data processing system 540 components can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 540, control system 118, or valve system 106) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 500 or system 800 can include clients and servers. A client and server are generally remote from each other and typically interact through a communication network (e.g., the network 101). The relationship of client and server arises by virtue of computer programs running on the respective computers and having a client-server relationship to each other. In some implementations, a server transmits data (e.g., data packets representing a digital component) to a client device (e.g., for purposes of displaying data to and receiving user input from a user interacting with the client device). Data generated at the client device (e.g., a result of measuring or receiving sensor data) can be received from the client device at the server (e.g., received by the data processing system 540 from the control system 118).

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware or software product. For example, the altitude controller 508 and the data collector 506 can be a single component, app, or program, or a logic device having one or more processing circuits, or part of one or more servers of the control system 118.

Having now described some illustrative implementations, it is apparent that the foregoing is illustrative and not limiting, having been provided by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1. A system, comprising:
a balloon, formed from a material having latex, comprising:
a top portion that is narrower than a middle portion of the balloon;
a bottom portion, that is narrower than the middle portion of the balloon, in contact with a cable to tether the balloon to a gondola;
a first valve, located at the top portion of the balloon, to open to release gas from within the balloon, and close to at least partially prevent the release of the gas from within the balloon; and
the gondola comprising:
a control system comprising one or more processors, coupled to memory, to open, responsive to a determination to decrease buoyancy of the system, the first valve to release the gas.

2. The system of claim 1, comprising:
a second balloon comprising:
a top portion narrower than a middle portion of the second balloon; and
a bottom portion, narrower than the middle portion of the second balloon, in contact with a second cable to tether the second balloon to the gondola; and
a second valve, located at the top portion of the second balloon, to communicate with the control system to open to release gas from within the second balloon.

3. The system of claim 1, comprising:
a cluster of at least three balloons each formed from latex and tethered to the gondola via at least one cable, the cluster comprising the balloon.

4. The system of claim 1, comprising:
a second balloon, formed from latex, comprising a bottom portion, narrower than a middle portion of the second balloon, in contact with a second cable to tether the second balloon to the gondola; and
a second valve, located at the bottom portion of the second balloon, to communicate with the control system to open to release gas from within the second balloon.

5. The system of claim 4, wherein the first valve at the top portion of the balloon releases the gas from within the balloon at a greater rate than the second valve located at the bottom portion of the second balloon releases the gas from within the second balloon.

6. The system of claim 4, wherein the control system stores, in one or more data structures in the memory, an indication that the first valve is located at the top portion of the balloon and the second valve is located at the bottom portion of the second balloon.

7. The system of claim 1, wherein the gas comprises at least one of hydrogen or helium.

8. The system of claim 1, wherein the top portion of the balloon has a shape based on a neck profile.

9. The system of claim 1, wherein the top portion comprises an attachment point to couple the first valve to the balloon.

10. The system of claim 1, wherein a first thickness of the material at the top portion of the balloon is greater than a second thickness of the material at the middle portion of the balloon.

11. The system of claim 1, comprising:
the first valve comprising an actuator and a first wireless interface card;
the control system comprising a second wireless interface card, the control system to:
establish a wireless communication channel between the second wireless interface card and the first wireless interface card; and
transmit, via the wireless communication channel, a signal to command the actuator to open the first valve to release the gas via the top portion of the balloon.

12. The system of claim 11, comprising the control system to:
receive, from a data processing system remote from the system, an instruction to at least one of decrease the buoyancy of the system or open the first valve; and
provide, responsive to the instruction received from the data processing system, the signal to command the actuator to open the first valve.

13. The system of claim 1, comprising:
the gondola comprising a ballast tank with a third valve to open to release a material from within the ballast tank; and
the control system to open, responsive to a determination to increase the buoyancy of the system, the third valve to release the material from the ballast tank.

14. The system of claim 1, comprising the control system to:
measure a current altitude of the system;
compare the current altitude of the system with a desired altitude for the system; and
determine, based on the comparison of the current altitude with the desired altitude, to decrease the buoyancy of the system.

15. A method, comprising:
providing a balloon, formed from a material having latex, comprising:
a top portion that is narrower than a middle portion of the balloon; and
a bottom portion, that is narrower than the middle portion of the balloon, in contact with a cable to tether the balloon to a gondola;
providing a first valve, located at the top portion of the balloon, to open to release gas from within the balloon, and close to at least partially prevent the release of the gas from within the balloon; and
providing a control system, comprising one or more processors coupled to memory, to open the first valve to release the gas.

16. The method of claim 15, comprising:
providing a second balloon, formed from latex, comprising a bottom portion, narrower than a middle portion of the second balloon, in contact with a second cable to tether the second balloon to the gondola; and
providing a second valve, located at the bottom portion of the second balloon, to communicate with the control system to open to release gas from within the second balloon.

17. The method of claim 15, wherein the top portion of the balloon has a shape based on a neck profile.

18. The method of claim 15, comprising:
identifying, by the control system, a current altitude of the control system;
comparing, by the control system, the current altitude with a desired altitude for the control system; and
determining, based on the comparison of the current altitude with the desired altitude, to open the first valve to release the gas.

19. An apparatus, comprising:
a balloon, formed from a material having latex, comprising:
a top portion that is narrower than a middle portion of the balloon;
a bottom portion, that is narrower than the middle portion of the balloon, in contact with a cable to tether the balloon to a gondola;
a valve system, coupled to the balloon via an attachment point on the top portion of the balloon, comprising an actuator, a valve, and a wireless interface card, the valve system to:
receive, from a control system comprising one or more processors, coupled to memory, a command to open the valve; and
actuate the valve to open the valve and release gas from within the balloon.

20. The apparatus of claim 19, wherein the top portion has a shape based on a neck profile, and a first thickness of the material at the top portion of the balloon is greater than a second thickness of the material at the middle portion of the balloon.
